(19) United States
(12) Patent Application Publication
(10) Pub. No.: US 2004/0227831 A1
(43) Pub. Date: Nov. 18, 2004

(54) Calibration scheme for logarithmic image sensor

(75) Inventors: Graeme Storm, Edinburgh (GB); Jonathan Ephriam David Hurwitz, Edinburgh (GB)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics Ltd., Marlow - Buckinghamshire (GB)

(21) Appl. No.: 10/820,463

(22) Filed: Apr. 8, 2004

(30) Foreign Application Priority Data
May 6, 2003 (EP) 03252836.6

(51) Int. Cl. H04N 5/335

(52) U.S. Cl. 348/294

(57) ABSTRACT

A logarithmic pixel is formed by a photodiode connected to a semiconductor device that is operating based upon a sub-threshold. A logarithmic output is taken from an output node connected to the pixel via an amplifier. To calibrate the pixel, the photodiode is isolated by a switch and a ramp voltage is applied as reference voltage to the amplifier. The ramp voltage acts across the constant internal capacitance of the pixel to produce in-pixel a constant current for calibration purposes.

### FIELD OF THE INVENTION

The present invention relates to electronics, and in particular, to a solid-state image sensor.

### BACKGROUND OF THE INVENTION

Dynamic range is a very important parameter of any imaging system. Human vision has the capability to see details across a wide illumination range in a single scene, and is reported to exhibit around 200 dB of dynamic range. Scenes in excess of 100 dB are not uncommon in everyday situations. Consequently, designers of CMOS and CCD image sensors are continuously looking for ways to increase dynamic range.

Sensors having logarithmic characteristics have been used to image scenes of high dynamic range. In a logarithmic mode the pixel voltage is continuously available and no integration time is used. In a typical CMOS arrangement, the induced photocurrent flows through one or more MOS transistors and sets up a gate-source voltage that is proportional to the logarithm of the photocurrent. This is shown in FIG. 1 where the gate-source voltage appears across the device M2. Since the photocurrent is very small, the MOS device(s) will operate in a sub-threshold, and the voltage varies logarithmically with the photocurrent. The voltage is read out by source follower circuitry. Around six decades of light can be captured in the logarithmic mode.

Due to the small size of the devices used in the pixels, a high degree of mismatch results from process variations, and produces fixed pattern noise (FPN) across the array. Logarithmic sensors cannot use double sampling (in its conventional form) for mismatch removal since this technique only removes the variation of the device M1 and does not alter the effect of device M2. This arises from the fact that the logarithmic architecture operates continuously in time and has no reference state.

Another disadvantage of the logarithmic arrangement is a slow response time for low light levels. Increased photocurrent for a given light level can be accomplished by increasing the size of the light sensing element, but this is not desirable since the cost for a given resolution will increase accordingly.

Calibrating the pixels addresses the FPN problem, that is, by bringing them into a reference state so that the FPN can be learned and then cancelled. The common way to calibrate a logarithmic pixel on-chip is to pull a matched current through the load device of each pixel using a current source in each column. This places the pixel into a known reference state that should be equivalent to illuminating the sensor with a uniform intensity. However, this requires an extra vertical line in each column for the current source, and the associated capacitance of the extra line prevents small calibration currents from settling quickly.

U.S. Pat. No. 6,355,965 to He et al. shows an arrangement in which a calibration access transistor shorts the source follower, and the calibration is performed without the need for an extra vertical line. But this still has problems of a long settling time for low photocurrents.

Kavadias discloses in the article “A Logarithmic Response CMOS Image Sensor With On-Chip Calibration”, IEEE Journal of solid-state circuits, vol. 35, No. 8, August 2000, a high calibration current being pulled through the load device. This disclosure uses an NMOS transistor and capacitor in a column instead of a constant current source. The calibration point can therefore be far from the operating point of the pixel due to the difference between photo and calibration currents.

Loose et al. discloses in the article “A Self-Calibrating Single-Chip CMOS Camera with Logarithmic Response”, IEEE Journal of solid-state circuits, vol. 36, No. 4, April 2001, a correction voltage being stored in an analog memory (a capacitor) in the pixel such that the signal voltage is free from offsets. The entire amplifier is in the column, and an extra vertical line is used to access the current source.

### SUMMARY OF THE INVENTION

The invention provides an image sensor as defined in claim 1, and a method of calibrating an image sensor as defined in claim 10. Preferred features and advantages of the invention will be apparent from the other claims and from the following description.

### BRIEF DESCRIPTION OF THE DRAWINGS

An embodiment of the invention will now be described, by way of example only, with reference to the drawings, in which:

FIG. 1 is a schematic diagram of a pixel in an image sensor according to the prior art; and

FIG. 2 is a schematic diagram of a pixel in an image sensor forming one example of the present invention.

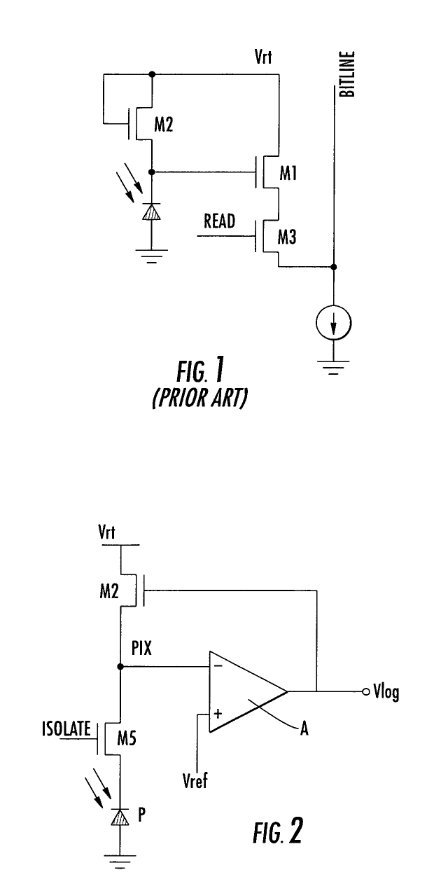

### DETAILED DESCRIPTION OF THE PREFERRED EMBODIMENTS

Referring to FIG. 2, a pixel has a photodiode P which causes a photocurrent to flow through device M2, thus causing it to operate in a sub-threshold (assuming device M5 is on). The photodiode voltage at the node pix is used as the inverting input to amplifier A. The non-inverting input receives a reference voltage Vref. The node pix will be held at the reference voltage Vref (plus the offset of the amplifier) and the logarithmic result will be available at the output of the amplifier A.

To calibrate the pixel, the node pix is isolated from the photodiode P by device M5 to eliminate the effects of the photocurrent. The reference voltage Vref is now ramped, and due to the amplifier feedback loop, the voltage at the node pix will try to track it. As the pixel voltage rises it will induce a current which must be supplied through M2.

The ramp voltage is applied to make use of the fact that a constant current can be generated if there is a constant voltage change across a constant capacitance. Using the formula I=C*dV/dt and knowing the capacitance, a voltage ramp can be programmed to produce a constant current.

In FIG. 2, the capacitance of the pixel is given by the capacitance on the drain of device M5 and the gate capacitance of the inverting input of the amplifier A. If these capacitances are well matched across the array then the calibration currents will be matched.

This arrangement allows the pixels to be calibrated without the use of additional vertical lines and current sources. It also allows very small calibration currents to be produced without the settling time problems associated with current sources and vertical access lines with large capacitance.

As well as providing a calibration current, the ramping of the reference voltage Vref can be used to aid the settling time of the circuit when the device M5 is on and the logarithmic voltage is dependent on the photocurrent. The node pix is able to charge up quickly as the feedback loop will cause the device M2 to turn on more quickly and supply more current. However, the node pix can only discharge with the current supplied from the photodiode P which could be very small and cause a very long settling time. If the amplifier has any overshoot then this settling time could be a problem for low photocurrents. By ramping the reference voltage Vref the oscillations can be absorbed by the ramp and at the end of the ramping period the circuit should settle more quickly.

The amplifier can be completely within the pixel, as shown. Alternatively, the amplifier could be formed partly within the pixel and partly within the column and switched between pixels as required. The invention thus provides an improvement in calibrating a logarithmic pixel.

1-10. (Cancelled).

11. An image sensor comprising:
an array of pixels, each pixel comprising
a photodiode,
a semiconductor device having a capacitance and being connected to said photodiode and operating based upon a sub-threshold for providing a signal that is proportional to a logarithm of light intensity on said photodiode, and
a calibration circuit having a capacitance and for applying a voltage having a constant rate of change across the capacitance associated with said semiconductor device and said calibration circuit for producing a constant current within said pixel.

12. An image sensor according to claim 11, wherein each pixel further comprises a switching device between said photodiode and said semiconductor device, said switching device being operable during calibration for isolating said photodiode from said semiconductor device.

13. An image sensor according to claim 12, wherein said calibration circuit comprises an amplifier having an inverting input for receiving the signal from said semiconductor device, a non-inverting input for receiving a reference voltage, and an output for providing a pixel output signal.

14. An image sensor according to claim 13, wherein the reference voltage comprises a ramp voltage for providing the voltage having the constant rate of change.

15. An image sensor according to claim 14, wherein the ramp voltage is also applied at a beginning of an image-capturing operation of said pixel.

16. An image sensor according to claim 13, further comprising a feedback loop between the output of said amplifier and said semiconductor device, the feedback loop for controlling said semiconductor device.

17. An image sensor according to claim 13, wherein each pixel has an image area associated therewith, and said amplifier for each respective pixel is completely within the corresponding image area.

18. An image sensor according to claim 13, wherein each pixel has an image area associated therewith, and wherein said amplifier for each respective pixel is partly within the corresponding image area.

19. An image sensor according to claim 13, wherein said semiconductor device comprises a transistor comprising a conducting terminal, and wherein the capacitance is provided by a capacitance of the conducting terminal and a capacitance of the inverting input of said amplifier.

20. An image sensor comprising:
an array of pixels, each pixel comprising
a photodiode;
a semiconductor device having a capacitance and being connected to said photodiode; and
a calibration circuit having a capacitance and for applying a voltage across the capacitance associated with said semiconductor device and said calibration circuit for producing a constant current within said pixel.

21. An image sensor according to claim 20, wherein the image sensor is operating in a logarithmic mode.

22. An image sensor according to claim 20, wherein each pixel further comprises a switching device between said photodiode and said semiconductor device, said switching device being operable during calibration for isolating said photodiode from said semiconductor device.

23. An image sensor according to claim 20, wherein said calibration circuit comprises an amplifier having an inverting input for receiving the signal from said semiconductor device, a non-inverting input for receiving a reference voltage, and an output for providing a pixel output signal.

24. An image sensor according to claim 23, wherein the reference voltage comprises a ramp voltage for providing the voltage having the constant rate of change.

25. An image sensor according to claim 24, wherein the ramp voltage is also applied at a beginning of an image-capturing operation of said pixel.

26. An image sensor according to claim 23, further comprising a feedback loop between the output of said amplifier and said semiconductor device, the feedback loop for controlling said semiconductor device.

27. An image sensor according to claim 23, wherein each pixel has an image area associated therewith, and said amplifier for each respective pixel is completely within the corresponding image area.

28. An image sensor according to claim 23, wherein each pixel has an image area associated therewith, and wherein said amplifier for each respective pixel is partly within the corresponding image area.

29. An image sensor according to claim 23, wherein said semiconductor device comprises a transistor comprising a conducting terminal, and wherein the capacitance is provided by a capacitance of the conducting terminal and a capacitance of the inverting input of said amplifier.

30. A method for calibrating an image sensor operating in a logarithmic mode, the image sensor comprising an array of pixels, each pixel comprising a photodiode, a semiconductor device having a capacitance and connected to the photodiode, and a calibration circuit having a capacitance and being connected to the semiconductor device, the method comprising:
applying a voltage having a constant rate of change across the capacitance associated with the semiconductor device and the calibration circuit for producing a constant current within the pixel during calibration.

31. A method according to claim 30, wherein each pixel further comprises a switching device between the photodiode and the semiconductor device; the method further comprising operating the switching device during calibration for isolating the photodiode from the semiconductor device.

32. A method according to claim 31, wherein the semiconductor device operates based upon a sub-threshold for providing a signal that is proportional to a logarithm of light intensity on the photodiode, and the calibration circuit comprises an amplifier having an inverting input for receiving the signal from the semiconductor device, a non-inverting input for receiving a reference voltage, and an output of the amplifier provides a pixel output signal.

33. A method according to claim 32, wherein the reference voltage comprises a ramp voltage for providing the voltage having the constant rate of change.

34. A method according to claim 33, wherein the ramp voltage is also applied as the reference voltage at a beginning of an image-capturing operation of the pixel.

35. A method according to claim 32, wherein each pixel further comprises a feedback loop between the output of the amplifier and the semiconductor device, the feedback loop for controlling the semiconductor device.

36. A method according to claim 32, wherein each pixel has an image area associated therewith, and wherein the amplifier for each respective pixel is contained completely within the corresponding image area.

37. A method according to claim 32, wherein each pixel has an image area associated therewith, and wherein the amplifier for each respective pixel is partly within the corresponding image area.

38. A method according to claim 32, wherein the semiconductor device comprises a transistor comprising a conducting terminal, and wherein the capacitance is provided by a capacitance of the conducting terminal and a capacitance of the inverting input of the amplifier.
